(19) United States
(12) Patent Application Publication
(10) Pub. No.: US 2013/0246358 A1
(43) Pub. Date: Sep. 19, 2013

(54) ONLINE VERIFICATION OF A STANDBY DATABASE IN LOG SHIPPING PHYSICAL REPLICATION ENVIRONMENTS

(71) Applicant: INTERNATIONAL BUSINESS MACHINES CORPORATION, Armonk, NY (US)

(72) Inventors: Prasadarao Akulavenkatavara, Portland, OR (US); Aaron I. Henner, Beaverton, OR (US); Gary N. Jin, Portland, OR (US); Steven R. Pearson, Portland, OR (US)

(73) Assignee: International Business Machines Corporation, Armonk, NY (US)

(21) Appl. No.: 13/886,111

(22) Filed: May 2, 2013

Related U.S. Application Data
(63) Continuation of application No. 13/360,962, filed on Jan. 30, 2012.

(51) Int. Cl. G06F 17/30

(52) U.S. Cl. CPC G06F 17/30581
USPC 707/634

(57) ABSTRACT

Techniques are disclosed for performing an operation for determining whether a standby database is synchronized with a primary database in a log shipping physical database replication environment. In one embodiment, the operation may include receiving a transaction log at the standby database from the primary database. The transaction log may specify a first one or more checksum values for a first set of pages on the primary database. The operation may also include calculating a second one or more checksum values for a second set of pages on the standby database. The operation may also include determining whether the standby database is synchronized with the primary database by comparing the first one or more checksum values with the second one or more checksum values.

### CROSS-REFERENCE TO RELATED APPLICATIONS

This application is a continuation of co-pending U.S. patent application Ser. No. 13/360,962, filed Jan. 30, 2012. The aforementioned related patent application is herein incorporated by reference in its entirety.

### BACKGROUND

Databases are computerized information storage and retrieval systems. Databases are operated by database management system (DBMS) that implement various techniques for storing, retrieving, and backing up data. Databases can use physical replication to keep a backup (standby) copy up-to-date. This ensures that if there is a problem with the original copy (primary), then the standby can assume the role of primary (takeover), and perform all database operations with current data. Users typically require continuous access to their data, and replication allows for minimal disruption. To ensure this protection, however, the standby must be active and ready to take over on a moment's notice.

Physical replication is founded on initially having two identical databases (either through disk-based replication or a database backup and restore). From that point on, the databases are kept in sync by a continual shipment of transactional log data from the primary to the standby. The standby then processes the log data and writes changes to disk. This is done continuously while the standby is active, so that it can takeover at any time.

In such a physical replication environment, it is very critical for customers to know that the standby has data identical to that of the primary, so that if a takeover happens there is no loss of data. The standby's data, however, may be incorrect due to errors including, but not limited to, disk errors, network errors, or errors in the replication method. Current methods for complete verification of the standby suffer from a loss of availability and disaster recovery capabilities on the standby system. Some current verification methods do not cover an entire database without significant user effort, and cannot cover metadata pages in any case. The current invention discloses a method to ensure that a standby database is identical to the primary while the replication process is in progress.

### SUMMARY

Embodiments provide a method, product and system for performing an operation for determining whether a standby database is synchronized with a primary database in a log shipping physical database replication environment. The operation includes receiving a transaction log at the standby database from the primary database. The transaction log specifies a first one or more checksum values for a first set of pages on the primary database. The operation also includes calculating a second one or more checksum values for a second set of pages on the standby database. The operation also includes determining whether the standby database is synchronized with the primary database by comparing the first one or more checksum values with the second one or more checksum values.

### BRIEF DESCRIPTION OF THE DRAWINGS

So that the manner in which the above recited aspects are attained and can be understood in detail, a more particular description of embodiments of the invention, briefly summarized above, may be had by reference to the appended drawings.

It is to be noted, however, that the appended drawings illustrate only typical embodiments of this invention and are therefore not to be considered limiting of its scope, for the invention may admit to other equally effective embodiments.

FIG. 1 is a block diagram illustrating a system for online verification of a standby database in log shipping physical replication environments, according to one embodiment of the invention.

FIG. 2 is a flowchart depicting a method for online verification of a standby database in log shipping physical replication environments, according to one embodiment of the invention.

FIG. 3 is a flowchart illustrating a method for generating a transaction log in a primary database, according to one embodiment of the invention.

FIG. 4 is a flowchart illustrating a method for verifying checksums of a primary database against a standby database.

FIG. 5 is a block diagram illustrating components of a database management system (DBMS), according to one embodiment of the invention.

FIG. 6 illustrates records stored in a transaction log according to one embodiment of the invention.

### DETAILED DESCRIPTION

Embodiments of the invention provide techniques for verifying a standby database in log shipping physical replication environments while the standby database is online. In one embodiment, an application verifies the standby database against the primary database. In some embodiments, the application is part of a database management system (DBMS). Further, the application may be configured to generate a transaction log for pages in a tablespace of the primary database. The transaction log contains checksum values of the physical data on a storage device representing each page of the database. After generating the log for all pages in the tablespace, the application sends the transaction log to the standby database. As is known to persons skilled in the art, the standby database may be managed by the same DBMS as the primary database, a different DBMS as the primary database and may be located within the same physical computer as the primary database or located in a different computer as the primary database. The application then computes a checksum for each page in the standby database and compares the corresponding checksum values from the primary and standby databases. The application alerts a user when the values are not equal, as this signifies that the page data in the standby database is not an identical copy of the page data in the primary database.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications or related data available in the cloud. For example, the online database verification application could execute on a computing system in the cloud and verify that the standby database is synchronized with the primary database (which itself could be stored as a hosted service by a cloud provider). In such a case, the online database verification application could generate a transaction log at the primary database and store transaction log data at a storage location in the cloud. Doing so allows a user to access this information from any computing system attached to a network connected to the cloud (e.g., the Internet).

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

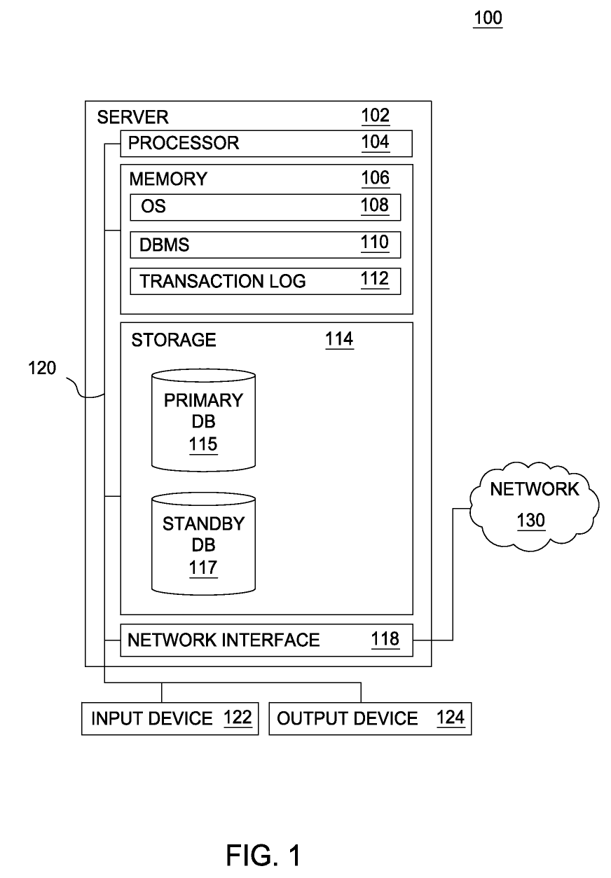

FIG. 1 is a block diagram illustrating a system 100 for verifying a standby database in a log shipping physical database replication environment while the standby database is online, according to one embodiment of the invention. The networked system 100 includes a server 102. The server 102 may also be connected to other computers and servers via a network 130. In general, the network 130 may be a telecommunications network and/or a wide area network (WAN). In a particular embodiment, the network 130 is the Internet.

The server 102 generally includes a processor 104 connected via a bus 120 to a memory 106, a network interface device 118, a storage 114, an input device 122, and an output device 124. The server 102 is generally under the control of an operating system 108. Examples of operating systems include UNIX, versions of the Microsoft Windows® operating system, and distributions of the Linux® operating system. More generally, any operating system supporting the functions disclosed herein may be used. The processor 104 is included to be representative of a single CPU, multiple CPUs, a single CPU having multiple processing cores, and the like. Similarly, the memory 106 may be a random access memory. While the memory 106 is shown as a single identity, it should be understood that the memory 106 may comprise a plurality of modules, and that the memory 106 may exist at multiple levels, from high speed registers and caches to lower speed but larger DRAM chips. The network interface device 118 may be any type of network communications device allowing the server 102 to communicate with other computers via the network 130.

The storage 114 may be a persistent storage device. Although the storage 108 is shown as a single unit, the storage 114 may be a combination of fixed and/or removable storage devices, such as fixed disc drives, solid state drives, floppy disc drives, tape drives, removable memory cards or optical storage. The memory 106 and the storage 114 may be part of one virtual address space spanning multiple primary and secondary storage devices.

The input device 122 may be any device for providing input to the server 102. For example, a keyboard and/or a mouse may be used. The output device 124 may be any device for providing output to a user of the server 102. For example, the output device 116 may be any conventional display screen or set of speakers. Although shown separately from the input device 122, the output device 124 and input device 122 may be combined. For example, a display screen with an integrated touch-screen may be used.

As shown, the memory 106 of the server 102 includes a database management system (DBMS) 110 configured to manage primary database 115 and standby database 117, contained in the storage 114 of the server 102. As stated above, one skilled in the art will recognize that standby database 117 can be stored in a different server, in a different storage unit of the same server, and can be managed by a separate DBMS. As shown, the memory 106 of server 102 also contains a transaction log 112. In one embodiment, the transaction log 112 contains a database page identifier, a corresponding checksum value, and a timestamp value. In some embodiments, the transaction log 112 may contain a value identifying itself as a “verification log,” such that it is used by DBMS 110 for verification purposes only. Embodiments of the invention may include any mechanism for maintaining timing and sequencing in place of a timestamp. A checksum value is a checksum of the physical data on a storage medium which represents a page of the database. The particular description in FIG. 1 is for illustrative purposes only; it should be understood that the invention is not limited to specific described embodiments, and any combination is contemplated to implement and practice the invention.

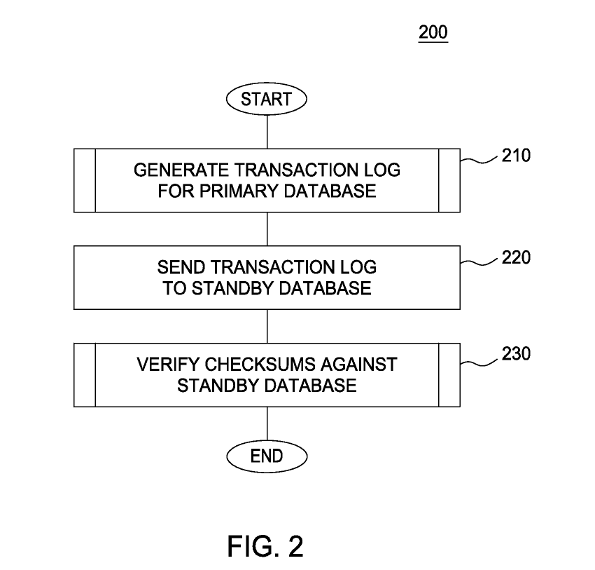

FIG. 2 is a flowchart illustrating a method for verifying a standby database according to one embodiment of the invention. As shown, the method begins at step 210, where DBMS 110 generates a transaction log 112 for each page in primary database 115. Database pages are the basic internal structure used to organize the data in the database files. In some embodiments, DBMS 110 may generate transaction logs for a subset of pages in the primary database 115. In some embodiments, a single transaction log may contain checksum values for multiple pages. In some other embodiments, a separate transaction log may be generated for each page, the transaction log containing a single page identifier and checksum value. It should be appreciated that any possible combination of transaction logs and page identifiers is contemplated, and should not be considered limiting of the disclosure. At step 220, the transaction log 112 generated at step 210 is sent to standby database 117 for further processing. At step 230, DBMS 110 uses the checksum information contained in transaction log 112 to verify each page in standby database 117 against primary database 115. By executing this method, an alert is sent to a user if DBMS 110 determines that the primary database 115 and standby database 117 are not synchronized.

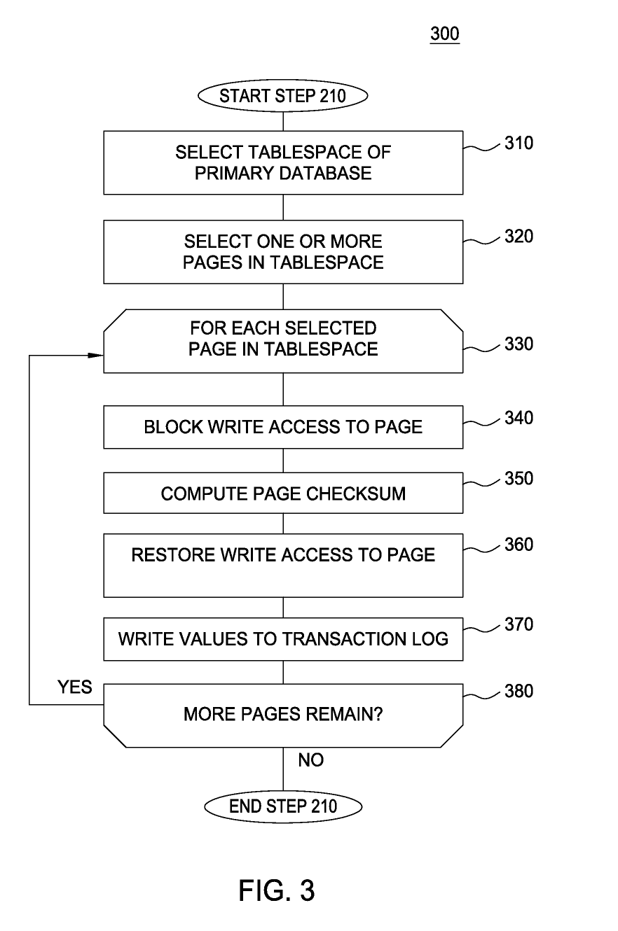

FIG. 3 is a flowchart showing a method 300 corresponding to step 210 for generating a transaction log 112 for primary database 115, according to an embodiment of the invention. As shown, the method 300 begins at step 310, where a tablespace of the primary database 115 is selected by DBMS 110. A tablespace is a logical group of data files (e.g., pages) in a database. A tablespace identifies a storage location at which the data underlying database objects can be stored. At step 320, DBMS 110 selects each of the pages in the tablespace selected at step 310. In one embodiment, DBMS 110 selects the pages sequentially. In another embodiment, DBMS 110 selects the pages randomly. In yet another embodiment, the DBMS selects the pages depending on the access patterns of the workload on primary database 115, such that concurrency is improved as temporary blocking of write access is required. Generally, DBMS 110 may use any suitable method for selecting each page in the tablespace. As stated above, in some embodiments, a subset of pages may be selected to be checksummed at step 320. In some embodiments, the subset of pages selected to be checksummed at step 320 may only include a single page.

At step 330, DBMS 110 begins executing a loop which includes steps 340-370 for computing a checksum for each selected page in the tablespace. Critical is the need to prevent modifications to each page while computing the checksum, as modifications to the physical data will result in a different checksum value for the page. Accordingly, at step 340, DBMS 110 blocks write access to the page. Again, doing so prevents the contents of the page from being modified as the checksum is computed. Write access can be blocked by any method which provides temporary exclusive access to the page, including, but not limited to, spin locks, semaphores, or latches. After blocking write access to the page, at step 350, DBMS 110 computes a checksum of the page in primary database 115. Any suitable checksum algorithm may be implemented to compute the checksum. A checksum is a fixed-size data object computed from a defined segment of physical storage data for the purpose of detecting errors that may have been introduced during transmission or storage. The integrity of data can be verified by recomputing a checksum and comparing it with the original checksum. If the checksums match, it is almost certain that the data is identical. Thus, by determining a checksum for each selected page in the tablespace of primary database 115 along with a checksum for each corresponding page in the tablespace of standby database 117, and comparing the corresponding checksum values, DBMS 110 can verify that standby database 117 is an exact copy of primary database 115.

At step 360, DBMS 110 restores write access to the page. That is, after computing checksum values, write access to the page is restored allowing subsequent database transactions to modify the pages. At step 370, DBMS 110 writes checksum values, page identifier information, and a transaction identifier to transaction log 112. The transaction identifier may include a timestamp or a log sequence identifier used to maintain timing integrity within the system. By including the transaction identifier, the point to which the verification has been completed is specified to a certain time or sequence number. The transaction identifier also ensures that the appropriate transaction logs are used in the checksum and comparison operations. In some embodiments, a single transaction log may be generated for a set of pages whose checksums have been computed, with each page identifier being written to the transaction log along with the computed checksum. In some other embodiments, a separate transaction log may be generated for each page whose checksum has been computed. At step 380, DBMS 110 determines whether more pages selected from the tablespace need to be checksummed. If so the method returns to step 330 to compute a checksum for another page. Once complete, step 210 ends.

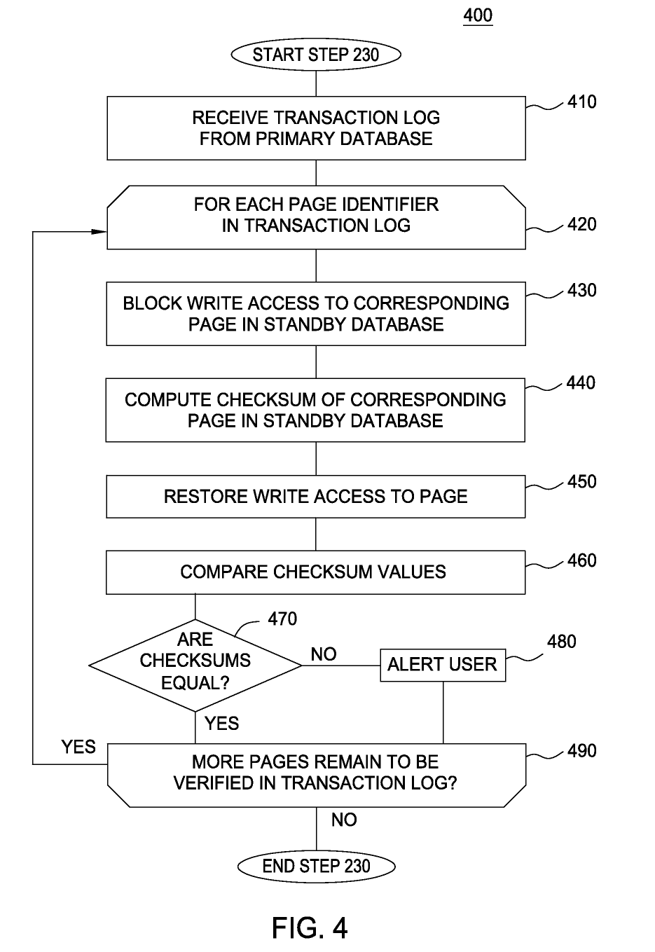

FIG. 4 illustrates a method 400 corresponding to step 230 for verifying checksums of the pages in a tablespace of standby database 117 against the checksums contained in transaction log 112 generated at step 210, according to an embodiment of the invention. As shown, the method 400 begins at step 410, where transaction log 112 generated at step 210 is received at standby database 117. Again, transaction log 112 may provide a set of page identifiers correlating to checksums calculated for each page. FIG. 4 depicts embodiments where a single transaction log was generated to store checksums for multiple pages. As discussed above, in other embodiments, separate transaction logs may be used, where each transaction log stores checksums for a single page. In those embodiments, each separate transaction log must be processed to compare the checksum values contained therein. In some embodiments, DBMS 110 may verify that transaction log 112 is intended to perform verification of a set of pages, as opposed to another database operation. Once received, at step 420, DBMS 110 conducts a checksum verification for each page identifier included in transaction log 112. At step 430, DBMS 110 begins executing a loop which includes steps 430-490 for comparing the checksum values for each page identifier in transaction log 112 against the corresponding page in standby database 117. At step 430, DBMS 110 blocks write access to the corresponding page in standby database 117. The method then proceeds to step 440, where DBMS 110 computes a checksum of the page in standby database 117. Once the checksum is computed, DBMS 110 restores write access to the page in standby database 117. At step 460, DBMS 110 compares the checksum generated at step 440 to the checksum in transaction log 112. The method proceeds to step 470, where, if DBMS 110 determines that the checksums are equal, the method proceeds to step 490. If the checksums are not equal, the method proceeds to step 480, where DBMS 110 alerts the user of an inconsistency between the page data in primary database 115 and standby database 117. The alert can be of any format sufficient to notify the user that a possible corruption of data has been found on the standby during verification, along with details of the corruption. Examples of alerts include email messages, popup messages, and sounds. The method then proceeds to step 490, where the method proceeds to step 420 if additional pages identified in transaction log 112 need to be verified against the standby database. Once the pages identified in transaction log 112 are verified, the method 400 ends.

In another embodiment, method 400 also includes self-consistency checks on standby database 117. Generally, the self-consistency checks are conventional file system checks and data integrity checks. For example, a self-consistency check may include DBMS 110 verifying read access to the standby database, detecting media failures, ensuring pointers link properly, and monitoring other system health metrics. The self-consistency checks may be scheduled to run on varying intervals, such as every nth iteration of the method 400, or at a specified time interval, and may be limited to a certain number of pages or all pages of an extent.

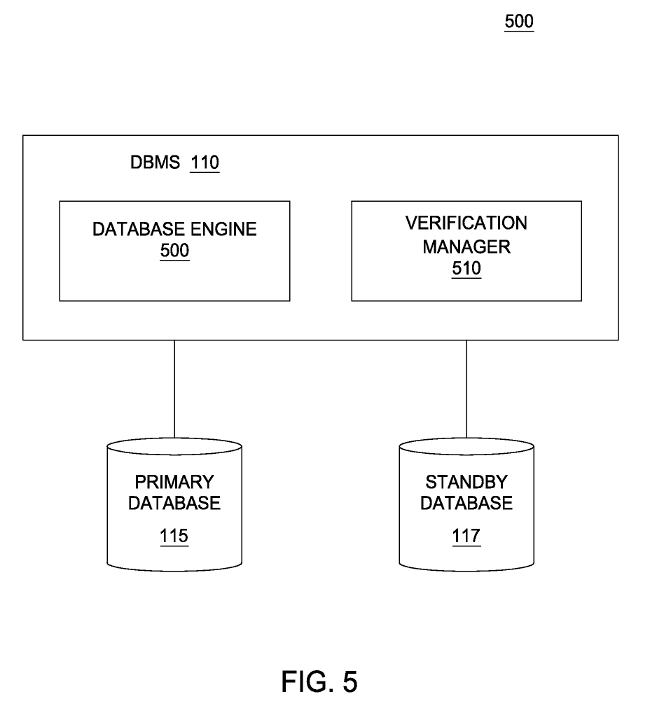

FIG. 5 is a block diagram illustrating components 500 of DBMS 110, according to one embodiment of the invention. As shown, DBMS 110 includes, without limitation, a database engine 500 and replication manager 510. Database engine 500 controls standard database functionality, such as reads, writes, queries and other database management tools. Although FIG. 5 depicts DBMS 110 managing primary database 115 and standby database 117, embodiments of the invention also include a separate DBMS for primary database 115 and standby database 117, each DBMS with its own instance of database engine 500 and replication manager 510. Replication manager 510 is an application configured to verify that a standby database is synchronized with a primary database in a log shipping physical database replication environment while the standby is online. In one embodiment, replication manager 510's verification process is intended to be performed as part of a log replay component of DBMS 110 already existing to perform log replays (replication) via log shipping, as described above. In such an embodiment, replication manager 510 enhances DBMS 110 by adding logic to process new verification log records by ensuring other earlier replays for the involved pages have finished, then performing the validation described below.

In one embodiment, replication manager 510 is configured to perform a series of operations, described in detail above, to verify a standby database in a log shipping physical database replication environment while the standby database is online. In one embodiment, replication manager 150 selects a set of pages in the primary database and generates a transaction log containing checksum values computed for each selected page at a specific time or sequence. Replication manager 150 then uses the information in the transaction log to verify the standby database. In one embodiment, replication manager 150 computes a checksum value for each page in the standby database and compares it to the corresponding value in the transaction log to verify the standby database. In one embodiment, a user is alerted by replication manager 150 when checksum values calculated for pages in the standby database do not match the corresponding values in the primary database. In one embodiment, replication manager 150 verifies that the standby database is synchronized with the primary database when the checksum value computed for each page of the standby database matches the corresponding checksum value for each page of the primary database. In some embodiments, replication manager performs self-consistency checks on the standby database while verifying the standby database.

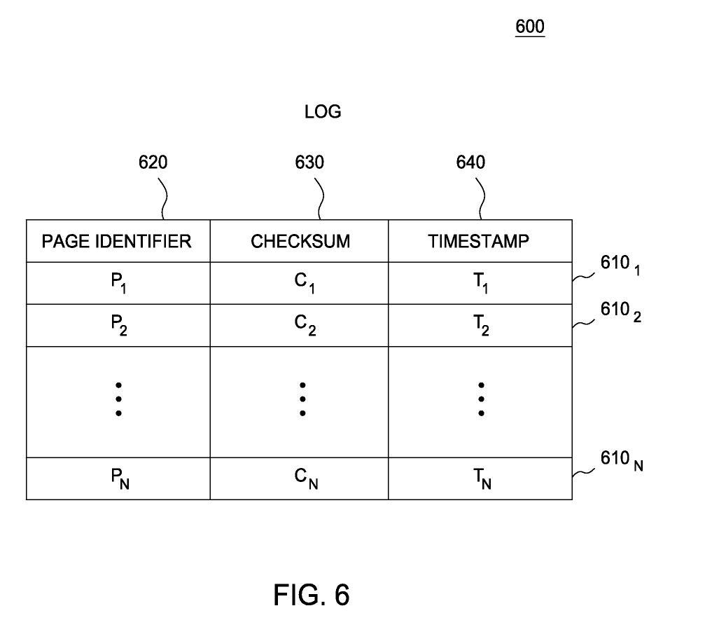

FIG. 6 is a block diagram illustrating records contained in transaction log 112 generated at step 210 of FIG. 2, according to an embodiment of the invention. As shown, each record 610_{1-N} includes a page identifier 620, a checksum value 630, and a timestamp 640. As stated above, any internal mechanism for maintaining timing/sequencing may be implemented in place of timestamp 640. For each record 610_{1-N} in the transaction log, a checksum is calculated for the page in standby database 117 corresponding to P_{1-N}, which is then compared to checksum value C_{1-N},which will produce a verification result current to T_{1-N}.

Thus, embodiments of the invention allow the primary and standby databases to be compared and validated while online. This approach avoids the need to idle the primary (even temporarily) and/or force a database-wide point of consistency on the primary or standby. Further, this approach does not require taking the standby database offline, converting the standby to a primary, or making a snapshot of the standby, to perform a complete validation and comparison between the primary and standby copies of the database. By using the database log as described herein, such a comparison may be completed online despite the fact that the primary and standby copies of the database never concurrently represent exactly the same point in time. Instead, the database log provides a rolling process for verifying synchronization as transactions occur and are processed by the primary and standby. That is, the standby synchronization state is evaluated in the order of the database log, such that the evaluation occurs exactly when the standby database's contents should match with the contents that the primary database had at the time when the log record (and checksum operation) occurred on the primary. This may be sub-seconds to hours apart in wall clock time, but is same in terms of database history time, as reflected in the database log generated on the primary.

While the foregoing is directed to embodiments of the present invention, other and further embodiments of the invention may be devised without departing from the basic scope thereof, and the scope thereof is determined by the claims that follow.

What is claimed is:

1. A computer-implemented method, comprising:
by operation of one or more computer processors, determining whether a standby database is synchronized with a primary database in a physical database replication environment, comprising:
receiving a transaction log at the standby database from the primary database, the transaction log specifying a first one or more checksum values for a first set of pages on the primary database;
computing a second one or more checksum values for a second set of pages on the standby database, wherein each page of the second set of pages from the standby database corresponds to a page in the primary database; and
comparing each of the first one or more checksum values against each of the corresponding second one or more checksum values to determine whether the standby database is synchronized with the primary database.

2. The computer-implemented method of claim 1, wherein the standby database is synchronized with the primary database when the checksum value for each of the pages in the primary database matches the checksum value for each corresponding page in the standby database.

3. The computer-implemented method of claim 2, further comprising: generating an alert upon determining that the standby database is not synchronized with the primary database.

4. The computer-implemented method of claim 1, further comprising performing at least one self-consistency check on the standby database in conjunction with computing the second one or more checksum values.

5. The computer-implemented method of claim 1, further comprising:
selecting a tablespace of the primary database;
selecting one or more pages in the tablespace;
blocking write access to the one or more pages;
computing a checksum value for each of the one or more pages;
restoring write access to the one or more pages; and
writing to the transaction log a page identifier for each selected page in the primary tablespace, the corresponding checksum value, and a transaction log identifier.

6. The computer-implemented method of claim 1, wherein generating the second one or more checksum values comprises:
reading each page identifier in the transaction log;
selecting pages in the standby database tablespace corresponding to the page identifiers in the transaction log;
blocking write access to the selected pages;
computing a checksum value for each selected page; and
restoring write access to the selected pages.
